(19) United States
(12) Patent Application Publication
(10) Pub. No.: US 2007/0214252 A1
(43) Pub. Date: Sep. 13, 2007

(54) CONTENT DISTRIBUTION APPARATUS SYSTEM AND METHOD

(76) Inventor: Regina L. Kushima, Ashland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/683,020

(22) Filed: Mar. 7, 2007

Related U.S. Application Data
(60) Provisional application No. 60/780,143, filed on Mar. 7, 2006.

(51) Int. Cl. G06F 15/173

(52) U.S. Cl. 709/223

(57) ABSTRACT

Embodiments of the present invention provide a content distribution system including a first distribution source located in a publicly accessible facility adapted to hold a first library of content items. A second distribution source adapted to hold a second library of content items, and a system control module is adapted to effect a transfer of a copy of selected content items from the second library to the first library. A transportable storage device is adapted to couple with the first distribution source for receiving a copy of one or more content items, and is further adapted to couple with a media player for playing the one or more content items. An interface is coupled with the distribution source and adapted to enable a user to copy the one or more content items from the first library of content items onto the transportable storage device.

### CROSS REFERENCE TO RELATED APPLICATIONS

The present application claims priority to U.S. Provisional Patent Application No. 60/780,143, filed Mar. 7, 2006 entitled “MEDIA RENTAL APPARATUS SYSTEM AND METHOD,” the entire disclosure of which is hereby incorporated by reference in its entirety.

### TECHNICAL FIELD

Embodiments of the present invention relate to the field of content distribution, and, more specifically, to a system, arrangement, and method wherein a transportable storage device may be adapted to receive selected content from a distribution device and to be used to play the content on a player, and wherein consumption and demand for particular items of content, and value added steps taken by various suppliers, may be monitored throughout the supply chain for efficient economic exchange.

### BACKGROUND

Millions of people worldwide rent media such as movies using one or more of a number of methods. The methods include: patronizing a “brick and mortar” facility such as BLOCKBUSTER®, Hollywood Video™, or Movie Gallery®; renting via mail, such as is available with Netflix®; downloading via the Internet such as is available via Movielink®, renting from an automated DVD rental kiosk such as is available with redbox™; or using a cable or satellite television service for “pay-per-view,” movies or obtain “Movies on Demand.”

Brick-and-mortar facilities typically require the overhead of store employees, have a limited inventory of movies, have a large storefront, and require a return trip to return the movie. Brick-and-mortar rentals, also require time and gas to travel to the store, browsing the store hoping that a selection is in-stock, waiting in line at the checkout stand, and remembering and making time to return the rental. Mail rental requires mail transit time, waiting on the speed of mail, loss or damage in transit (which may lead to delayed and/or restricted rental privileges). Internet downloading typically requires a computer, Internet access, and requires long download times which may take hours in some cases. Also, the delays inherent with some of these methods may not satisfy a consumer's need for immediate gratification. Automated DVD rental kiosks (redbox™) are limited to the stock at hand and requires a return trip. Pay per view, or movies on demand require subscription fees.

So called “Movies on Demand” and movies resident at a person's home lack the emotional feel of an “event,” or something purposefully obtained for sheer value of treating oneself. Renting a movie from a video store may provide a consumer with the satisfaction of being treated or of doing something eventful. However, making a special trip to a video store can often not be justified when the time and fuel to get there is considered.

In addition, adding additional content to audio and visual content has been used for years to modify behavior such as purchasing decisions by end consumers. For example, advertising has been added before or after content items, and more and more the practice of product placement has been included in media content such as movies. The effectiveness of the added content is not always clearly understood.

Further, the effectiveness of various value-added steps taken by various suppliers along the content supply chain is not clearly understood, nor is there a quantitative way to understand the value added actions, and to provide equitable compensation thereof.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIGS. 1A and 1B illustrate schematic views in accordance with various embodiments of the present invention;

FIGS. 2A and 2B illustrate schematic views of various network configurations in accordance with various embodiments of the present invention; and

FIG. 3 illustrates a schematic view illustrating a system in accordance with various embodiments of the present invention.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B).” For the purposes of the description, a phrase in the form “at least one of A, B, and C” means “(A), (B), (C), (A and B), (A and C), (B and C), or (A, B and C).” For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the present invention, methods, apparatuses, and systems for providing content to a user such as video or audio content to be rented or purchased are provided. In exemplary embodiments of the present invention, a computing system may be endowed with one or more components of the disclosed apparatuses and/or systems and may be employed to perform one or more methods as disclosed herein.

Various embodiments of the invention may provide a clear and quantitative way to understand and compensate the various suppliers of content and services on the content supply chain. Various embodiments may enable a better understanding of consumer behavior based on modifications made to various content items.

The following definitions may apply when describing various embodiments of the invention:

Advertisement placement: Variant of product placement, in which an advertisement for a product (rather than the product itself) is seen or described in a content item.

Content consumer or user: A purchaser or renter of a content item.

Content item: A transferable content item such as, but not limited to, visual media such as, but not limited to, a movie or television show, or audio media such as, but not limited to, music, or narrations, and the like.

Content modifier: A stakeholder in a content distribution system in accordance with various embodiments of the invention who by agreement with a content provider or a rental module manager has included into a content item additional content for the purpose of eliciting a response such as a buying decision from a content consumer, including, but not limited to, advertising, product placement, or advertising placement.

Content provider: A creator or owner of a content item.

Content supply chain: A coordinated system of creators, suppliers, financiers, distributors, facility owners/managers, and customers, and the like arranged to control the flow of content from its source to its point of use, and may include but may not be limited to: users, distribution source managers; content providers; content modifiers; and Publicly accessible facilities.

Modified content: Content that has been modified by including one or more, but not limited to, Product Placement, advertising placement, or advertising.

Distribution source: An apparatus capable of providing a content item to a user.

Distribution source manager: The owner or manager of one or more distribution sources.

Economic exchange: An exchange of one or more items of value including a monetary exchange.

Publicly accessible facility: A place accessible to the general public where a rental module can be located, such as, but not limited to, a store, airport, library, restaurant, or a bank.

Product placement (PPL): A promotional tactic in which a real commercial product of a product provider is used in a media content item.

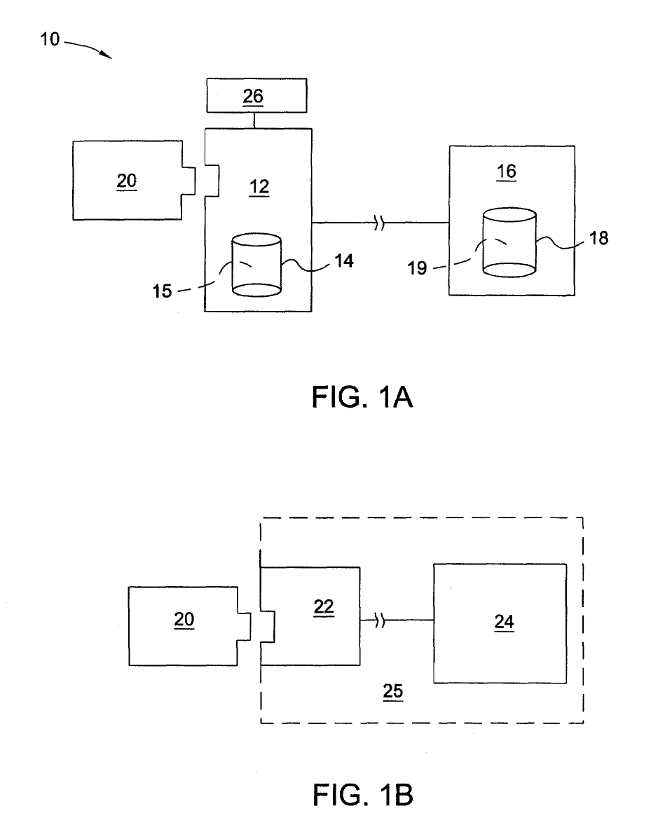

FIGS. 1A and 1B are schematic views illustrating various embodiments in accordance with the invention. Turning first to FIG. 1A, a content distribution system 10 may include a first distribution source 12, which may include a first memory 14 adapted to hold a first library of content items 15. A second distribution source 16 may be operatively coupled to the first distribution source 12 and may have a second storage 18 adapted to hold a second library of content items 19. A transportable storage device 20 may be operatively coupled to the first distribution source 12 for copying and/or downloading the one or more content items from the first or second library to the transportable storage device 20, and may be adapted to be easily carried by a user. Turning next to FIG. 1B, a player interface 22 may be operatively coupled to the transportable storage device 20 and further adapted to transfer signals to a media player 24 based on the content items. In various embodiments the player interface 22, and the media player 24 may be an integrated unit 25. The media player 24, and/or the integrated unit 25 may include devices such as, but not limited to, desktop computers, a laptop computers, and televisions.

In various embodiments, a large number of content items may be stored on the master source in the second library 19, and a smaller number of content items may be stored in the first library 15 resident in the first distribution source 12. Files may be transferred from the second library to the first library based on various criteria including, but not limited to: expected demand, actual demand, advertising, special offers, release dates, or usage rates.

The first distribution source 12 may be located in a publicly accessible facility, including, but not limited to, a store, a coffee shop, a library, or a mass transit station. The first distribution source 12 may be, for example, a substantially freestanding kiosk, or may be coupled with or be part of a customer check-out apparatus such as, for example, a manned cash register or a self serve check-out apparatus. The first distribution source 12 may include a user interface 26 which may include an input device, such as, for example, a keyboard, and may include a monitor, or other display. In one embodiment, the monitor may be adapted to allow a user to sample a portion of the one or more content items. The user interface 26 may be adapted to receive input including, but not limited to, for example, selection data, selection commands, user identification data and payment data. The identification and/or verification data, and/or the payment data, may be on the transportable storage device 20.

In various embodiments according to the invention, a user may perform certain operations regarding copying the content items. For example, if the user is a first time user, he or she may purchase the transportable storage device 20 either from the first distribution source 12, near the first distribution source 12, or from another location. For example, a new customer may purchase, or rent, the transportable storage device 20 in ways including, but not limited to, mail, Internet, phone, or a customer center. In the case of a user obtaining the transportable storage device at the first distribution source 12, the first distribution source 12 may be stocked with an inventory of transportable storage devices 20. The transportable storage device 20 may be available for purchase, rent, or to borrow as a condition of renting and/or purchasing one or more content items wherein a storage device may be dispensed upon user actions. The user may include input data including, but not limited to utilization data, or means for paying for the service such as, for example, with a credit card. When obtaining the transportable storage device 20, all or a portion of such input data may then remain on the transportable storage device 20. In various embodiments, the transportable storage device may be a Compact Disc (CD) or a Digital Video Disc (DVD), or the like, and the content item may be “burned” onto the CD or DVD and may be available for purchase by the user.

If the user is experienced with the system, for example, is an existing customer, he or she may couple the transportable storage device 20 with the first distribution source 12 by, for example, plugging it into a socket in the distribution source. The distribution source may then verify user information and account information. The user may be prompted to input a password.

The user may access a database, browse the database, sample the content items, and make one or more selections using user interface 26 of the first distribution source 12. The database may reflect the contents of one or both of the first library 15 or the second library 19. Before or after a selection is made the user may couple the transportable storage device 20 to the first distribution source 12, then copy the one or more content items. The transportable storage device 20 may then be decoupled from the first distribution source 12, and coupled to the player interface 22 to transfer the selection to a media player 24 integrated unit 25. The player interface 22 may be located, for example, in the user's home. The player interface 22, or an additional player interface, may be near, or integral with, the first distribution source 12 to facilitate sampling.

In accordance with various embodiments, the selection may be a movie. In various embodiments, the selection may include so called “special features.” In various embodiments, the content item may include television programming. In various embodiments, a selection may include advertising which may help defray some or all the cost of using the system 10. Various embodiments may prevent fast forwarding the advertising. The system may include an opt-in, or an opt-out option for the advertising.

Once a user is done with the content items, he or she may return to the same distribution source or to a similarly constituted distribution source to load another selection. Such action may erase, or disable the previous selection, i.e., may constitute rental period expiration. Various embodiments may disable use of the media after a predetermined amount of time, or after a predetermined number of uses. Automatic expiration may eliminate the urgency to make a return trip to avoid late fees, and may therefore provide customer convenience. Various expiration times may be specified, or selected, by the user and may or may not affect the rental price. Various embodiments may use encryption techniques so that the media may only be played, for example, viewed, but not copied.

Various embodiments may include a tiered cost structure depending on the selection made and based on various criteria including, but not limited to: demand, age of the selection, i.e., a new release just of a new release “list,” or old movie, licensing structure, on copyright conditions, and whether or not the content item(s) includes advertising.

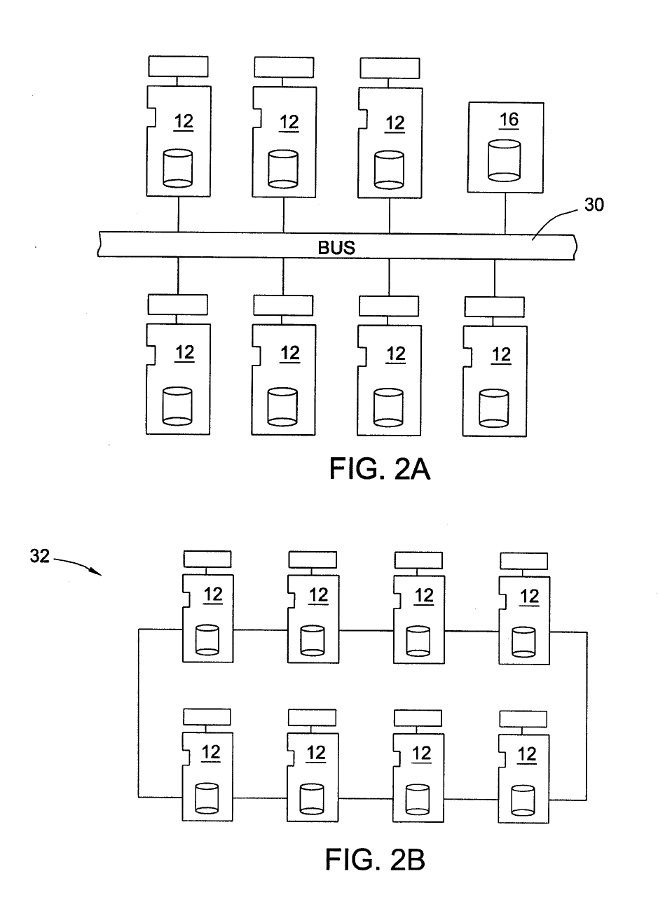

FIGS. 2A and 2B are schematic views illustrating various networking arrangements according to various embodiments of the invention. FIG. 2A illustrates a plurality of first distribution sources 12, each of which may be operatively coupled with a network bus 30. A second distribution source 16 may also be operatively coupled with the network bus 30. The second distribution source 16 may be a master source and may contain a relatively larger library of content items. The master source 16 may be regularly updated with new or requested content items. FIG. 2B illustrates two or more first distribution source 12 adapted to be connected in a local area network (LAN) 32. Various arrangements are possible with various embodiments. The one or more first distribution sources may be adapted to function as a second distribution source and may provide copies of content items thereto. One or more first distribution sources 12 and one or more second distribution sources 16 may be connected via various network architectures including the Internet.

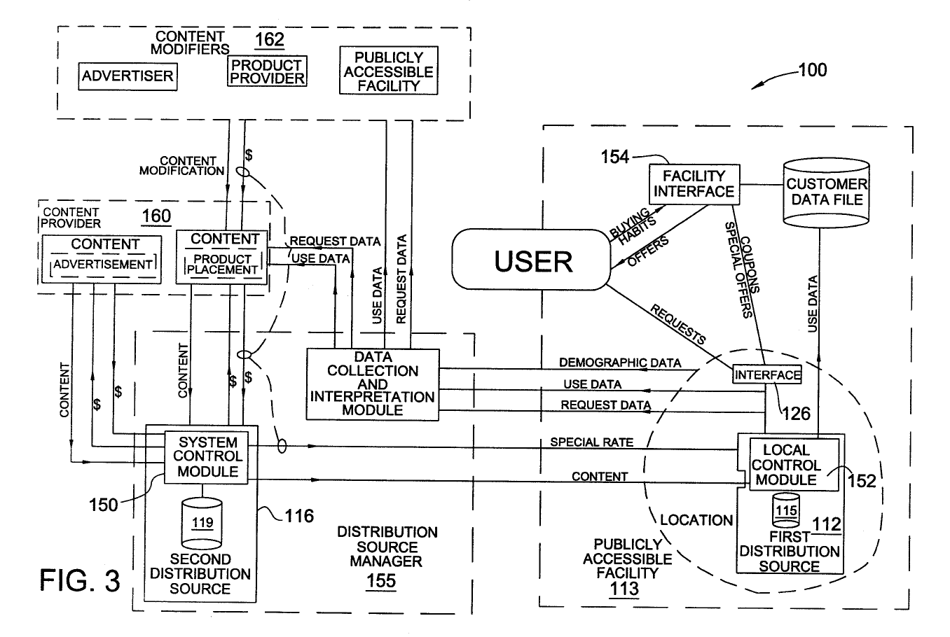

FIG. 3 is a schematic view illustrating a content distribution system 100 according to various embodiments in accordance with the invention. A first distribution source 112 may be located in a publicly accessible facility 113 and may be adapted to hold a first library 115 of content items. A second distribution source 116 may be adapted to hold a second library 119 of content items. A system control module 150 may be adapted to effect a transfer of a copy of selected content items from the second library 119 to the first library 115. A transportable storage device (not illustrated) may be adapted to couple with the first distribution source 112 for receiving a copy of one or more content items, and may be further adapted to couple with a media player (not illustrated) for playing the one or more content items. An interface 126 may be coupled with the first distribution source 112 and may be adapted to enable a user to copy the one or more of the content items from the first library 115 of content items onto the transportable storage device (not shown in this view).

In various embodiments, the interface 126 may be adapted to allow the user to selectively opt in or opt out of playing advertising wherein if the user opts, in the content item may include advertising. The user will then be unable to play the content item without also playing the advertising. If the user opts out of playing or accepting advertising, the content item may then not include advertising, or the user may then have the option of not playing, and/or skipping and/or fast-forwarding through the advertising.

In some embodiments the user may choose a content item that includes advertising and may enable, request or require the user to provide feedback regarding the advertising. The feedback may be in the form of opinion questions, and/or questions to test the user's recollection of the advertising. The results of the feedback may generate feedback results that may be made available to one or both of a content provider or a content modifier. The feedback results may be used by a content modifier to test the effectiveness of the content that has been modified, which may clarify its value and aid in clarifying and/or quantifying aspects of a contractual relationship between the content provider and the content modifier.

Various embodiments may enable certain levels of control such as parental controls to enable parents to control the content that may be accessible to their children. For example, the interface and/or the transportable storage device 120 may be adapted to selectively encode the content item to restrict playback of the content item to selected users having access to a decoding key and/or a decoding command.

In various embodiments the system control module 150 may be adapted to provide availability information regarding a certain content item, or enable a user to request that a given content item be transferred from the second library 118 to the first library 115 to be available to be copied onto the transportable storage device from the first library 115. The system control module 150 may be further adapted to receive the request from one or more selected from a group comprising: a cell phone, a land line phone, an Internet connection, a text-messaging device, a personal digital assistant (PDA), and a call center. For example, a user may be driving or about to drive to a store and may check the availability of a particular content item at a particular first distribution source. If the particular content item is unavailable, the user may then use the cell phone to request that a copy of the particular content item be transferred from the second distribution source to the first distribution source and made resident in the first library for copying by at least that user.

In various embodiments, a user may use one or more selected items from the group consisting of a cell phone, a landline phone, an Internet connection, a text-messaging device, a PDA, and a call center and may simply vote or request in a non-committal way to have a particular content item be made available at a particular first distribution source. The content item may be already available in the second library, or may not be available within the system at all. Various individuals or entities responsible for managing the system according to various embodiments of the invention may then procure, or otherwise make available to the first distribution source the particular content item based on the number of votes, which may be interpreted as a demand.

For example, the user and other users can vote to have a voted-for content item available for copying from the first library, the system control module 150 may be further adapted to make the voted-for content item available if a number of votes exceeds a predetermined threshold.

In various embodiments, one or both of the system control module 150 and the interface 126 may be adapted to debit the user a first amount for copying the one or more of the content items to the transportable storage device 120 if the one or more of the content items is resident in the first library 115, and to debit the user a second amount if the one or more of the content items needs to be transferred to the first library 115.

In various embodiments, one or both of the system control module 150 and the interface 126 may be adapted to credit the user a third amount for each subsequent copying of the one or more content items by one or more other users. This may be valuable for a user in that a user may expend a greater amount of rental or purchasing cost to obtain, for example, an unusual content item, but have the possibility that the costs be defrayed when and if other users also download the selection from the same first distribution source or if the selection is obtained elsewhere.

Various coupling arrangements may be provided to couple the first library and second library. For example, the first library and the second library may be coupled for transferring content items via the Internet.

Various embodiments may include a local control module 152 coupled with, or resident in, the first distribution source 112. A facility interface 154 may be resident in, or accessible to, the publicly accessible facility 113 and may be adapted to compile and interpret consumption behavior of the user of goods and/or services provided by the publicly accessible facility 113. The local control module 152 may be coupled with the facility interface 154 and may be co-adapted to effect an economic exchange between one of the user and the distribution source 112, or the publicly accessible facility 113 and the distribution source 112. An economic exchange may be made between the owner or manager of the publicly accessible facility 113 and the owner or distribution source manager 155 of the first and/or second distribution sources 112/116. The system control module 150 and the local control module may be separate but operatively coupled modules as indicated in FIG. 3, or they may be made integral.

Various embodiments may include an economic exchange as a promotional incentive provided to the user to elicit a purchase at the publicly accessible facility. For example, local control module 152 and/or the interface 126 may cause a coupon to be printed or may notify the user of a special price on one or more particular goods or services within the publicly accessible facility 113. The economic exchange may also be, or include an incentive such as an economic incentive to copy a particular content item onto the transportable storage device.

In various embodiments the economic exchange may be a function of the type of consumption behavior the user exhibits in the publicly accessible facility 113. For example, if one or more items from a first set of goods and/or services is purchased by the user from the publicly accessible facility 113, then the economic exchange may be a credit to the publicly accessible facility 113 from the distribution source manager 155, and if one or more items from a second set of goods and/or services is purchased by the user from the publicly accessible facility 113, then the economic exchange may be a credit to the distribution source manager 155 from the publicly accessible facility 113. In various circumstances, an individual may come to the publicly accessible facility 113, for example, a grocery store, for the purpose of buying regular groceries. In other circumstances a person may come to the same facility in particular for the purpose of obtaining a copy of a content item from the first distribution source. The different cases may represent different motivations by the consumer, and the motivations may be determined by the buying habits of that consumer. If the consumer purchases a number of items from a first set of goods or services, for example, items typically purchased during weekly, or long term, grocery shopping, then one may conclude that a rental or purchase of a content item was a result of the person coming to the grocery store to do his or her weekly shopping. However, if the items purchased by the consumer are from a set of goods more likely to be impulse purchases and/or items that would be associated purchases for consuming while viewing or listening to a content item, for example, popcorn, then one may conclude that the reason the consumer was at the facility in the first place was first to rent or purchase a content item, and then to purchase goods. In order words, the distribution source 112 may have attracted the consumer to the grocery store. In such a case, the publicly accessible facility 113 may be considered to have benefited from the presence of the distribution source, and it may be concluded that a fair exchange of the price to rent grocery store floor space may be adjusted slightly in the favor of the owner or manager of the distribution source 155. If the consumer came into the store first for buying items in the store and then also purchased or rented a content item, one may conclude the owner or manager of the distribution source 155 benefited from being located in the publicly accessible facility 113. Fair adjustment may be made accordingly.

In various embodiments the system control manager 150 may be further adapted to compile utilization data indicative of which content items are copied and how many copies are made of specified content items, the utilization data may be made available to one or both of a content provider 160 and a content modifier 162 to effect an economic exchange between a content provider and a content modifier based on the presence or absence of either or both of product placement and advertisement placement. The utilization data may be indicative of the number of times a content item is viewed or listened to and therefore may also be indicative of the number of times a modified content, i.e., content that includes one or more of advertising, product placement, or advertising placement is seen or heard by a consumer. The content provider 160 may then be in a more powerful negotiating position with the content modifier 162 regarding compensation for including modified content within a content item.

The modified content may be made more valuable if the effects may be quantified. Various embodiments in accordance with the invention may enable the effect of specific modified content to be quantified. For example, a facility interface 154 which may be resident in, or accessible to, the publicly accessible facility 113, and may be adapted to compile and interpret consumption behavior of the user of goods and/or services provided by the publicly accessible facility as consumption data. The consumption data and the utilization data may be made available to the content modifier 162 to track changes in the user's consumption behavior after a predetermined amount of time after having copied a particular content item. For example, whether or not a consumer purchased and/or increased their purchasing of a particular consumer product shown in a movie.

Various embodiments according to the invention may include a first distribution source 112 located in a publicly accessible facility 113 and adapted to hold a first library 115 of content items. A transportable storage device (not shown) may be adapted to couple with the first distribution source 112 for receiving a copy of one or more content items, and further adapted to couple with a media player (not shown) for playing the one or more content items. An interface 126 may be coupled with the first distribution source 112 and may be adapted to enable a user to copy the one or more content items from the first library 112 of content items onto the transportable storage device. The interface 126 may be further adapted to allow the user to selectively opt in or opt out of playing advertising wherein if the user opts in, the one or more content items may include advertising and cannot be played without also playing advertising. If the user opts out the one or more content items may not include advertising or the user may have an option of not playing, and/or skipping and/or fast-forwarding through the advertising. The interface may be further adapted to charge the user a first fee if the user opts in and a second fee if the user opts out. The transportable storage device may also be adapted to receive user inputted information from the media player corresponding to answers provided by the user to questions regarding the one or more content items. The interface and/or the system control module, and/or the local control module may be further adapted to provide the user an economic exchange for answering the questions.

Various embodiments according to the invention may provide a method. The method may be a computer-enabled method and may include:

locating a first distribution source having a first library of content files in a publicly accessible facility;

adapting the first distribution source to enable a user to copy one or more content items from the first library onto a transportable storage device to be played with a media player for playing the one or more content items;

compiling utilization data indicative of which content items are copied and how many copies are made of specified content items; and

making the utilization data available to one or more of a set consisting of a distribution source manager; a content provider; a content modifier, and the publicly accessible facility.

In various embodiments the local control module and/or the system control module may be adapted to provide modified content to a content item specific to the needs or plans of the publicly accessible facility. For example, an advertisement may appear before a movie selection advertising an upcoming grocery store special. In such circumstances, in accordance with various embodiments, the publicly accessible facility may then be considered to be a content modifier.

Various methods according to embodiments of the invention may include linking the location of the first distribution source with demographic data of residents in a predetermined area surrounding or adjacent to the location of the publicly accessible facility with utilization data as demographic utilization data; and

effecting an economic exchange between one or more of the distribution source manager 155; the content provider 160; the content modifier 162, and the publicly accessible facility according 113 to prearranged criteria and based on the demographic utilization data.

Various embodiments may also include effecting an economic exchange between one or more of the distribution source manager 155; the content provider 160; the content modifier 162, and the publicly accessible facility 113 according to prearranged criteria and based on the utilization data.

Returning again to FIGS. 1A, 1B 2A and 2B, various embodiments may be adapted for other arrangements including, but not limited to: stand-alone non-networked first distribution source 12; one or more first distribution source 12 adapted to couple to the Internet directly or via one or more servers; one or more first distribution source 12 adapted to couple with one or more servers in a LAN; one or more first distribution sources 12 adapted to couple to multiple master sources 16.

Various embodiments according to the invention may include a method for renting media such as, but not limited to, video media. The method may include a computerized system, and may perform one or more of the following operations:

(a) receiving media selection data from a user at a publicly located distribution source;

(b) copying one or more content items to a transportable storage device based on the media selection data;

(c) coupling the transportable storage device with a media player located at a location selected by the user; and

(d) playing the media at the location selected by the user.

Various embodiments may further comprise (e) transferring user information from the transportable storage device at the publicly located distribution source. Various embodiments may further comprise returning to the distribution source, or to a similarly constituted publicly located distribution source and repeating one or more of operations (a), (b), (c), (d), and (e).

In various embodiments the transportable memory device 20 according to various embodiments in accordance with the invention. The transportable memory device 20 may use solid state memory or a hard drive in portable form. The solid state memory may include but may not be limited to USB Flash Drives (thumb drives), SecureDigital™ (SD), miniSD™, microSD™, MemoryStickPro™, MemoryStickProDuo™, CompactFlash®, xD-Picture Card™, TransFlash™, RC-MMC™ (Reduced Size MultiMedia Card) and MMCmobile™ memory. A hard drive may include, but may not be limited to, any disc based mechanical storage device such as microdrive, laptop drives, and portable devices with hard drives. Various embodiments may utilize a media player such as an iPod®.

The transportable storage device 20 may function as a portable storage mechanism that may have the ability to play the protected, secured video files. Content items may be secured using technology such as, but not limited to, the Microsoft® Windows Media® DRM (Digital Rights Management) Platform or RealNetworks® HeliX™ DRM.

In various embodiments, content items may be licensed appropriately for the devices they may be played with, such as, but not limited to: set-top boxes for television, home theater play, portable video devices, computers running Windows®, Linux®, or Mac OS® and may depend on the DRM technology chosen.

In various embodiments the first distribution source 12 may be the primary method of acquiring content items, for example, video files. The first distribution source 12 may be equipped to couple with and communicate with various devices designed to use various standards including, but not limited to, USB, Flash, or other media reader. As mentioned the first distribution source 12 may be stocked with an inventory of transportable media devices.

The media may be stored locally, for example, in the first memory 14 as discussed. Files may be stored on the first distribution source 12 or on a caching server as necessary. This may allow for quick transfer of files to the transportable storage device 20. Content items may be delivered to the first distribution source 12 or caching server beforehand via a high-speed connection, for example, an Internet connection. This may eliminate download time from the second distribution source 16. The second distribution source 16 may be an Internet server. The first distribution source 12 may include hardware according to DRM technology. DRM technology may require specific hardware and may be configured to use various operating systems (OS).

Various embodiments of the invention may include a player interface and/or the media player which may alone or collectively be referred to as a Digital Media Player (DMP). The player interface may be a set-top box. Set-top box may be used to refer to any multimedia device used in conjunction with a television or home theater. Set-top boxes may expand the user's multimedia capability. Such devices may include DVD players, CD players, and VHS players. The DMP may be a module in a set-top box or the set-top box, and may provide an interface for the transportable media device. The DMP may allow one to watch movie files similar to current use of DVDs in that it may enable use of selection and navigation features, and viewing of special features, and the like. The player interface may have video outputs similar to DVD players to and may couple the DMP to a TV. The DMP may use menu navigation to get to movies or scenes. Play, rewind, fast-forward may operate as one would expect. A remote control may be included with various embodiments. The DMP may be equipped with USB, Flash, or other media reader.

The DMP may include hardware according to DRM technology. The DRM technology may require specific hardware and operating systems. The DMP may be authorized as necessary, made capable by DRM technology, and may require synchronizing with a computer or direct connection over Internet. The DMP may be compatible with and/or associated with other equipment. The DMP may have the ability to, but may not limited to, enable a user to watch Digital cable, play DVDs, and play Music CDs. The DMP could be made into modules of hardware and software (dependent on DRM technology) for use in third-party equipment. For example, it may be compatible with TiVo® technology.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A content distribution system comprising:
a first distribution source located in a publicly accessible facility adapted to hold a first library of content items;
a second distribution source adapted to hold a second library of content items;
a system control module adapted to effect a transfer of a copy of selected content items from the second library to the first library;
a transportable storage device adapted to couple with the first distribution source for receiving a copy of one or more content items, and further adapted to couple with a media player for playing the one or more content items; and
an interface coupled with the first distribution source adapted to enable a user to copy the one or more content items from the first library of content items onto the transportable storage device.

2. The content distribution system of claim 1, wherein the interface is adapted to allow the user to selectively opt in or opt out of playing advertising, wherein if the user opts in, the content item includes advertising and cannot be played without also playing the advertising, and if the user opts out, the content item does not include advertising or the user has an option of not playing, and/or skipping and/or fast forwarding through the advertising.

3. The content distribution system of claim 1, wherein the user may choose a content item including advertising and requiring the user to provide feedback regarding the advertising such as opinion questions, and/or questions to test the user's recollection of the advertising and generating feedback results available to one or both of a content provider or a content modifier.

4. The content distribution system of claim 1, wherein the interface and/or the transportable storage device is adapted to selectively encode the content item to restrict playback of the content item to selected users having access to a decoding key and/or a decoding command.

5. The content distribution system of claim 1, wherein the system control module is adapted to enable a user to request that a given content item be transferred from the second library to the first library to be available to be copied onto the transportable storage device from the first library, the system control module being further adapted to receive the request from one or more selected from a group comprising: a cell phone, a landline phone, an Internet connection, a text messaging device, a personal digital assistant (PDA), and a call center.

6. The content distribution system of claim 1 wherein the user and other users may vote to have a voted-for content item available for copying from the first library, the system control module being further adapted to make the voted-for content item available if a number of votes exceeds a predetermined threshold.

7. The content distribution system of claim 1, wherein one or both of the system control module and the interface are adapted to debit the user a first amount for copying the one or more of the content items to the transportable storage device if the one or more of the content items is resident in the first library and a second amount if the one or more of the content items needs to be transferred to the first library.

8. The content distribution system of claim 7, wherein one or both of the system control module and the interface are adapted to credit the user a third amount for each subsequent copying of the one or more content items by one or more other users.

9. The content distribution system of claim 1, wherein the first library and the second library are coupled for transferring content items via the Internet.

10. The content distribution system of claim 1, further comprising a local control module coupled with or resident in the first distribution source, a facility interface resident in or accessible to the publicly accessible facility and adapted to compile and interpret consumption behavior of the user of goods and/or services provided by the publicly accessible facility, the local control module coupled with the facility interface and being co-adapted to effect an economic exchange between one of the user and the distribution source, or the publicly accessible facility and the distribution source.

11. The content distribution system of claim 10, wherein the economic exchange is one of a promotional incentive provided to the user to elicit a purchase at the publicly accessible facility or an economic incentive to copy a particular content item onto the transportable storage device.

12. The content distribution system of claim 10, wherein the economic exchange is a function of the type of consumption behavior wherein if one or more items from a first set of goods and/or services is purchased by the user from the publicly accessible facility then the economic exchange is a credit to the publicly accessible facility from the distribution source, and if one or more items from a second set of goods and/or services is purchased by the user from the publicly accessible facility, then the economic exchange is a credit to the distribution source from the publicly accessible facility.

13. The content distribution system of claim 1, wherein the system control manager is further adapted to compile utilization data indicative of which content items are copied and how many copies are made of specified content items, the utilization data being made available to one or both of a content provider and a content modifier to effect an economic exchange between a content provider and a content modifier based on the presence or absence of either or both of product placement and advertisement placement.

14. The content distribution system of claim 13, further comprising a facility interface resident in or accessible to the publicly accessible facility and adapted to compile and interpret consumption behavior as consumption data of the user of goods and/or services provided by the publicly accessible facility, the consumption data and the utilization data being made available to the content modifier to track changes in the user's consumption behavior after a predetermined amount of time after having copied a particular content item.

15. An apparatus comprising:
a first distribution source located in a publicly accessible facility adapted to hold a first library of content items;
a transportable storage device adapted to couple with the first distribution source for receiving a copy of one or more content items, and further adapted to couple with a media player for playing the one or more content items; and
an interface coupled with the distribution source adapted to enable a user to copy the one or more content items from the first library of content items onto the transportable storage device, the interface being further adapted to allow the user to selectively opt in or opt out of playing advertising wherein if the user opts in, the one or more content items include advertising and cannot be played without also playing the advertising, and if the user opts out, the one or more content items do not include advertising or the user has an option of not playing, and/or skipping and/or fast-forwarding through the advertising.

16. The apparatus of claim 15, wherein the interface is further adapted to charge the user a first fee if the user opts in and a second fee if the user opts out.

17. The apparatus of claim 15, wherein the transportable storage device is further adapted to receive user inputted information from the media player corresponding to answers provided by the user to questions regarding the one or more content items, the interface being further adapted to provide the user an economic exchange for answering the questions.

18. A computer enabled method comprising:
locating a first distribution source having a first library of content files in a publicly accessible facility;
adapting the first distribution source to enable a user to copy one or more content items from the first library onto a transportable storage device to be played with a media player for playing the one or more content items;
compiling utilization data indicative of which content items are copied and how many copies are made of specified content items; and
making the utilization data available to one or more of a set comprising a distribution source manager, a content provider, a content modifier, and the publicly accessible facility.

19. The computer enabled method of claim 18, further comprising linking the location of the first distribution source with demographic data of residents in a predetermined area surrounding or adjacent to the location of the publicly accessible facility with utilization data as demographic utilization data; and
effecting an economic exchange between one or more of the distribution source manager, the content provider, the content modifier, and the publicly accessible facility according to prearranged criteria and based on the demographic utilization data.

20. The computer enabled method of claim 18, further comprising effecting an economic exchange between one or more of the distribution source manager, the content provider, the content modifier, and the publicly accessible facility according to prearranged criteria and based on the utilization data.
